(19) United States
(12) Patent Application Publication
(10) Pub. No.: US 2008/0301292 A1
(43) Pub. Date: Dec. 4, 2008

(54) POWER MANAGEMENT OF NETWORK ATTACHED DEVICE

(75) Inventor: Makoto OYA, Sumida-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Buffalo Inc., Nagoya (JP)

(21) Appl. No.: 12/130,576

(22) Filed: May 30, 2008

(30) Foreign Application Priority Data
Jun. 1, 2007 (JP) 2007-146536

(51) Int. Cl. G06F 15/16

(52) U.S. Cl. 709/224

(57) ABSTRACT

Power management of one or more network-attached devices connected to a plurality of computer units is disclosed. In an exemplary arrangement, each computer unit as one computer unit, in response to a command for shutdown of the one computer unit, determines whether or not at least one remaining computer unit has been placed in a shutdown state, and the one computer unit, in response to a determination that the at least one remaining computer unit has been placed in a shutdown state, transmits a terminate-command signal to the one or more network-attached devices via the network for termination of the one or more network-attached devices.

### CROSS-REFERENCE TO RELATED APPLICATIONS

The present application is based on and claims the benefit of priority from Japanese Patent Application No. 2007-146536 filed Jun. 1, 2007, the content of which is incorporated herein by reference in its entirety.

### BACKGROUND OF THE INVENTION

1. Field of the Invention

The invention relates to improvements in techniques of power management for one or more devices which are sharable by a plurality of computer units, in an environment in which the computer units are communicatable with the one or more devices via a wired or wireless network.

2. Description of the Related Art

There is available an environment in which a plurality of computer units (e.g., server devices and client devices) are communicatable with one or more devices which are sharable by the computer units, via a wired or wireless network.

As an example of such a device available in such a communication environment, there exists a Network Attached Storage (NAS). An example of a technique of architecting a network using a NAS is disclosed in Japanese Patent Application Publication No. 2004-151824, which is incorporated hereinto by reference in its entirety.

In general, a NAS is configured to include a recordable hard disc, and a motor for driving the hard disc. The motor is driven by the power supplied from a power supply.

### BRIEF SUMMARY OF THE INVENTION

In general, for devices attached to computer units, it is desirable to save power consumption and reduce operational noises, by eliminating useless operation, irrespective of whether each device is used in a network connection environment (i.e., a device-sharing structure) or an one-by-one connection environment (i.e., a device-non-sharing structure).

In this regard, the network connection environment allows a plurality of computer units to be communicatable with one or more devices sharable by the plurality of computer units, via a wired or wireless network, while the one-by-one connection environment allows each computer unit to be directly connected to a device or a group of devices, in one-on-one correspondence.

More specifically, in an example where such a device is the aforementioned NAS, and the NAS is provided with a cooling fan for cooling the aforementioned motor, elimination of useless operation of the NAS would, of course, reduce the power consumption of the NAS, and would also eliminate useless operation of the cooling fan, with a concurrent reduction of operational noises of the NAS.

When a device is used in the aforementioned one-by-one connection environment, for optimizing power management of the device, it is enough to monitor the state (i.e., an active state or an inactive state), and to control the power of the device according to the monitoring results.

When, however, a device is used in the aforementioned network connection environment, the same device is shared by a plurality of computer units. Therefore, in this case, optimal power management of the device cannot be achieved only by taking the same approach as is taken when the device is used in the aforementioned one-by-one connection environment.

On the other hand, an automated shutdown technique has been proposed as a technique of reducing power consumption and operational noises of a device which is in the form of a NAS used in the aforementioned network connection environment.

In the automated shutdown technique, there is previously identified an inactive time zone (e.g., a time zone from 10:00 p.m. of one day to 5:00 a.m. of the next day) during which it is expected that none of a plurality of computer units sharing the same device is used, and, during the inactive time zone, not only a main power supply of the NAS but also an auxiliary power supply of the NAS are shutdown automatically.

In addition, a sleeping technique has been also proposed as a technique of reducing power consumption and operational noises of a device which is in the form of a NAS used in the aforementioned network connection environment.

In the sleeping technique, if a duration exceeds a given time limit, during which none of a plurality of computer units access a NAS shared by the plurality of computer units, then only a main power supply of the NAS is automatically shutdown, with an auxiliary power supply of the NAS being kept active, to thereby stop rotation of a hard disc of the NAS (i.e., enter a sleep mode).

However, in the case where the above-described automated shutdown technique is employed, if one of users of computer units that share the same NAS happens to make an attempt to activate the user's own computer unit and access the NAS during the inactive time zone, then the user's attempt is unsuccessful because all the power supplies of the NAS have been shutdown, which invites disadvantages.

In addition, in the case where the above-described sleeping technique is alternatively employed, if one of users of computer units that share the same NAS happens to make an attempt to activate the user's own computer unit and access the NAS in the aforementioned sleep mode in which rotation of a hard disc of the NAS has been stopped, then the user's attempt is successful because an auxiliary power supply of the NAS is kept active.

However, after a main power supply of the NAS is turned on, there is a waiting time for the rotation speed of a hard disc of the NAS to return to normal. This invites the NAS' slow response to external access to the NAS and can invite disadvantages.

The above-described automated shutdown technique and the sleeping technique, although applicable to situations in which devices other than a NAS (e.g., network-related devices such as routers, and household electrical appliances or devices such as media players or television sets) are used in the aforementioned network connection environment, can invite the similar kinds of disadvantages for the similar reasons, to those of the above-described cases of a NAS.

In the background of the foregoing circumstances, the invention has been made for providing techniques of power management for one or more devices which are sharable by a plurality of computer units, in an environment in which the computer units are communicatable with the one or more devices via a wired or wireless network, for making it possible to eliminate useless operation of the one or more devices, while ensuring successful accesses of each computer unit to the one or more devices, irrespective of when to access, with an improved response time.

In general, the invention relates to techniques for power management of one or more network-attached device shared by one or more computer units.

According to some aspects of the invention, each of a plurality of computer units, which is referred hereinafter to as “one computer unit” transmits a terminate-command signal to the shared one or more network-attached devices, in response to shutdown of the one computer unit, provided that all of at least one remaining computer unit which shares the one or more network-attached devices with the one computer unit has been placed in a shutdown state. In response to reception of the terminate-command signal, the shared one or more network-attached devices enter an inactive state, from an active state.

It is noted here that, as used in this specification, the singular form “a,” “an,” and “the” include plural reference unless the context clearly dictates otherwise. It is also noted that the terms “comprising,” “including,” and “having” can be used interchangeably.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic diagram conceptually illustrating a network for suitably practicing a method for power management of a network-attached device, which method is constructed according to a first illustrative embodiment of the present invention;

FIG. 2 is a block diagram conceptually illustrating the hardware construction of a representative one of four PCs (Personal Computers) depicted in FIG. 1;

FIG. 3 is a block diagram conceptually illustrating the hardware construction of a NAS (Network Attached Storage) depicted in FIG. 1;

FIG. 4 is a flow chart conceptually illustrating a PC-side program to be executed by each PC depicted in FIG. 1;

FIG. 5 is a flow chart conceptually illustrating a NAS-side program to be executed by the NAS depicted in FIG. 1;

FIG. 6 is a schematic diagram conceptually illustrating a network for suitably practicing a method for power management of network-attached devices, which method is constructed according to a second illustrative embodiment of the present invention; and

FIG. 7 is a flow chart conceptually illustrating a PC-side program to be executed by each PC depicted in FIG. 6.

### DETAILED DESCRIPTION OF THE INVENTION

General Overview of the Invention

According to a first aspect of the invention, there is provided a method for power management of a single device which is shared by a plurality of computer units, in an environment in which the computer units are communicatable with the device via a wired or wireless network.

This method comprises:

a determining step of determining, by each computer unit as one computer unit, in response to a command for shutdown of the one computer unit, whether or not at least one remaining computer unit has been placed in a shutdown state; and

a first transmitting step of transmitting, by the one computer unit, in response to a determination that the at least one remaining computer unit has been placed in a shutdown state, a terminate-command signal to the device via the network for termination of the device.

Throughout the specification, the term “one computer unit” is used to identify one of the plurality of computer units for the convenience of distinguishable description from the at least one remaining computer unit.

According to a second aspect of the invention, there is provided a method for power management of each of a plurality of devices sharable by a plurality of computer units, in an environment in which the computer units are communicatable with the devices via a wired or wireless network.

This method comprises a determining step of determining, by each computer unit as one computer unit, in response to shutdown of the one computer unit, whether or not at least one selected computer unit has been placed in a shutdown state.

In this regard, the at least one selected computer unit belongs to at least one remaining computer unit which is other than the one computer unit, the at least one selected computer unit has been assigned at least one of the devices, and the at least one device has been assigned to the one computer unit, whereby the at least one device is shared by the at least one selected computer unit and the one computer unit.

This method further comprises a first transmitting step of transmitting, by the one computer unit, a terminate-command signal via the network to all or a part of the at least one shared device.

In this regard, the all or the part of the at least one shared device has been assigned to at least one other computer unit, and the at least one other computer unit has been determined to be placed in a shutdown state.

According to a third aspect of the invention, there is provided a computer unit which constitutes a network together with at least one other computer unit and which shares a single device with the at least one other computer unit, the device being connected to the network.

This computer unit comprises:

a determining device configured, operable in response to a command for shutdown of the computer unit, to determine whether or not the at least one other computer unit has been placed in a shutdown state; and

a transmitter configured, operable in response to a determination that the at least one other computer unit has been placed in a shutdown state, to transmit a terminate-command signal to the device via the network for termination of the device.

According to a fourth aspect of the invention, there is provided a computer unit which constitutes a network together with at least one other computer unit and which shares at least one device with the at least one other computer unit, the at least one device belonging to a plurality of devices that are connected to the network.

This computer unit comprises a determining device configured, operable in response to a command for shutdown of the computer unit, to determine whether or not at least one selected computer unit has been placed in a shutdown state.

In this regard, the at least one selected computer unit belongs to the at least one other computer unit, the at least one selected computer unit has been assigned at least one of the devices, and the at least one device has been assigned to the computer unit, whereby the at least one device is shared by the at least one selected computer unit and the computer unit.

This computer unit further comprises a transmitter configured to transmit a terminate-command signal via the network to all or a part of the at least one shared device.

In this regard, the all or the part of the at least one shared device has been assigned to at least one other computer unit, and the at least one other computer unit has been determined to be placed in a shutdown state.

### ILLUSTRATIVE EMBODIMENTS OF THE INVENTION

According to the invention, the following modes are provided as illustrative embodiments of the invention.

According to a first mode of the invention, there is provided a method for power management of a single device which is shared by a plurality of computer units, in an environment in which the computer units are communicatable with the device via a wired or wireless network.

This method comprises:

a determining step of determining, by each computer unit as one computer unit, in response to a command for shutdown of the one computer unit, whether or not at least one remaining computer unit has been placed in a shutdown state; and

a first transmitting step of transmitting, by the one computer unit, in response to a determination that the at least one remaining computer unit has been placed in a shutdown state, a terminate-command signal to the device via the network for termination of the device.

This method allows the one computer unit to transmit the terminate-command signal to the device, in response to a command for shutdown of the one computer unit, provided that all of the at least one remaining computer unit which shares the device with the one computer unit has been placed in a shutdown state. In response to reception of the terminate-command signal, the device enters an inactive state, from an active state.

That is to say, this method allows the one computer unit to enter an inactive state (i.e., terminate), from an active state, in a linked relation to the state transition of the plurality of computer units sharing the same device.

Therefore, this method, when at least one of the plurality of computer units which share the device together has been placed in an active state, prevents the device from nevertheless entering an inactive state and making it unsuccessful for an active computer unit to attempt to access the device.

Further, this method, when all the plurality of computer units which share the device together has been placed in a shutdown state, allows the device to enter an inactive state, from an active state, to thereby eliminate useless operation of the device.

Throughout this specification, the term “terminate-command signal” may be interpreted to mean, for example, a command signal for shutdown of both a main power supply and an auxiliary power supply of the device, or a command signal (i.e., a sleep-command signal) for shutdown of only the main power supply of the device, with the auxiliary power supply being kept active, to thereby deactivate a movable portion (e.g., a motor) within the device.

In addition, the “terminate-command signal” may be defined as, for example, a signal used exclusively for deactivating the device, or otherwise a signal used non-exclusively for deactivating the device and for other purposes.

Throughout this specification, the term “computer unit” may be interpreted to mean, for example, a desktop computer (e.g., a personal computer), a portable computer (e.g., a server device, a client device, a PDA, or a mobile phone), unless otherwise defined.

According to a second mode of the invention, there is provided the method according to the first mode, further comprising a second transmitting step of transmitting, by the one computer unit, in response to power-on of the one computer unit, an activate-command signal to the device via the network for activation of the device.

This method allows the one computer unit to transmit the activate-command signal to the device, in response to power-on of the one computer unit. In response to reception of the activate-command signal, the device enters an active state, from an inactive state.

In other words, this method allows the device to enter an active state from an inactive state (i.e., activate), in response to a change in the operative state of the plurality of computer units which share the device.

Therefore, this method, when at least one of the plurality of computer units which share the device together has been placed in an active state, prevents the device from nevertheless being kept inactive and making it unsuccessful for an active computer unit to attempt to access the device.

Further, this method, when all the plurality of computer units which share the device together has been placed in a shutdown state, allows the device to be kept inactive, to thereby eliminate useless operation of the device.

Throughout this specification, the term “activate-command signal” may be interpreted to mean, for example, a command signal for activation of both a main power supply and an auxiliary power supply of the device, or a command signal for activation of only the main power supply of the device, with the auxiliary power supply being kept active, to thereby activate a movable portion (e.g., a motor) within the device.

In addition, the “activate-command signal” may be defined as, for example, a signal used exclusively for activating the device, or otherwise a signal (e.g., a conventional signal to be entered for requesting an access of each computer unit to the device, into the interface) used non-exclusively for activating the device and for other purposes.

According to a third mode of the invention, there is provided the method according to the first or second mode, wherein the device is configured to have a motor as an actuator.

According to a fourth mode of the invention, there is provided the method according to the third mode, wherein the device is configured to have a storage in which a recordable hard disc is driven by the motor.

According to a fifth mode of the invention, there is provided the method according to any one of the first through fourth modes, wherein the device is configured to have a regenerator for regenerating video or voice.

According to a sixth mode of the invention, there is provided a method for power management of each of a plurality of devices sharable by a plurality of computer units, in an environment in which the computer units are communicatable with the devices via a wired or wireless network.

This method comprises:

a determining step of determining, by each computer unit as one computer unit, in response to a command for shutdown of the one computer unit, whether or not at least one selected computer unit has been placed in a shutdown state,

wherein the at least one selected computer unit belongs to at least one remaining computer unit which is other than the one computer unit,

wherein the at least one selected computer unit has been assigned at least one of the devices, and

wherein the at least one device has been assigned to the one computer unit, whereby the at least one device is shared by the at least one selected computer unit and the one computer unit; and

a first transmitting step of transmitting, by the one computer unit, a terminate-command signal via the network to all or a part of the at least one shared device,

wherein the all or the part of the at least one shared device has been assigned to at least one other computer unit, and

wherein the at least one other computer unit has been determined to be placed in a shutdown state.

This method, when a plurality of devices are used for a plurality of computer units, provides basically the same effects, according to basically the same principle, as those of the method according the first mode.

According to a seventh mode of the invention, there is provided the method according to the sixth mode, further comprising a second transmitting step of transmitting, by the one computer unit, in response to power-on of the one computer unit, an activate-command signal to via the network at least one of the devices which has been assigned to the one computer unit, for activation of the at least one device.

This method, when a plurality of devices are used for a plurality of computer units, provides basically the same effects, according to basically the same principle, as those of the method according the second mode.

According to an eighth mode of the invention, there is provided a computer-executable program which, when executed by a computer, effects the method according to any one of the first through seventh modes.

This program, upon executed by a computer, would provide basically the same functions and effects according to the basically the same principle, as the method according to any one of the first through seventh modes.

The program according to this mode may be interpreted as, for example, a combination of a set of instructions implemented by a computer to perform the function(s) of the program, and associated files, data or the like to be processed according to the instructions.

In addition, this program may be interpreted as, for example, a structure which achieves the intended purpose(s) by being solely executed by a computer, or a structure which achieves the intended purpose(s) by being executed by a computer together with another program or other programs. In the latter case, the program according to this mode may be constructed mainly as a data structure, for example.

According to a ninth mode of the invention, there is provided a computer-readable medium having stored therein the program according to the eighth mode.

The program which has been stored in this medium, upon executed by a computer, provides the same functions and effects as the method according to any one of the first through seventh modes.

This medium may be realized in any one of a variety of types, including a magnetic recording medium, such as a flexible-disc, an optical recording medium, such as a CD and a CD-ROM, an optical-magnetic recording medium, such as an MO, an un-removable storage, such as a ROM, for example.

According to a tenth mode of the invention, there is provided a computer unit which constitutes a network together with at least one other computer unit and which shares a single device with the at least one other computer unit, the device being connected to the network.

This computer unit comprises:

a determining device configured, operable in response to a command for shutdown of the computer unit, to determine whether or not the at least one other computer unit has been placed in a shutdown state; and

a transmitter configured, operable in response to a determination that the at least one other computer unit has been placed in a shutdown state, to transmit a terminate-command signal to the device via the network for termination of the device.

This computer unit is used for practicing the method according to the first mode in a suitable manner.

According to an eleventh mode of the invention, there is provided a computer unit which constitutes a network together with at least one other computer unit and which shares at least one device with the at least one other computer unit, the at least one device belonging to a plurality of devices that are connected to the network.

This computer unit comprises:

a determining device configured, operable in response to a command for shutdown of the computer unit, to determine whether or not at least one selected computer unit has been placed in a shutdown state,

wherein the at least one selected computer unit belongs to the at least one other computer unit,

wherein the at least one selected computer unit has been assigned at least one of the devices, and

wherein the at least one device has been assigned to the computer unit, whereby the at least one device is shared by the at least one selected computer unit and the computer unit; and

a transmitter configured to transmit a terminate-command signal via the network to all or a part of the at least one shared device,

wherein the all or the part of the at least one shared device has been assigned to at least one other computer unit, and

wherein the at least one other computer unit has been determined to be placed in a shutdown state.

This computer unit is used for practicing the method according to the sixth mode in a suitable manner.

Several preferred embodiments of the invention will be described in more detail by reference to the drawings in which like numerals are used to indicate like elements throughout.

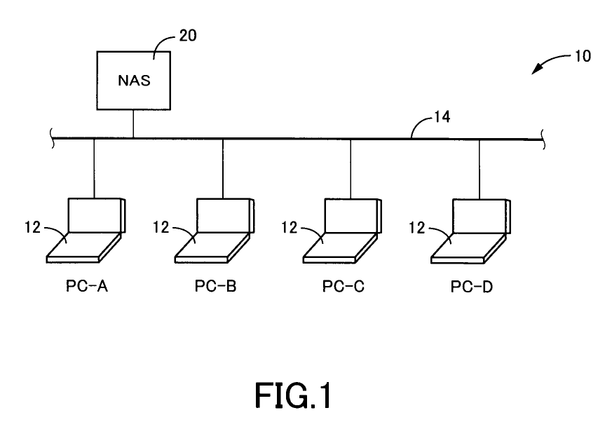

FIG. 1 conceptually illustrates a network system 10 which is used for suitably implementing a method for power management of a network-attached device, which method is constructed in accordance with a first illustrative embodiment of the present invention.

In the network system 10, there are four personal computers (hereinafter, each abbreviated as “PC”) 12 which are communicatably and electrically connected with one another via a wired or wireless network 14 (e.g., a LAN, a WAN, the Internet, etc.).

The four PCs 12 are used by respective users. For the illustrative purpose, the four PCs 12 are referred to as “PC-A,” “PC-B,” “PC-C,” and “PC-D,” respectively, for denotational distinction.

To the network 14, a single NAS (Network Attached Storage) 20 is connected. The NAS 20 is configured to be shared by the four PCs 12. Accordingly, any one of the four PCs 12 is made accessible to the NAS 20.

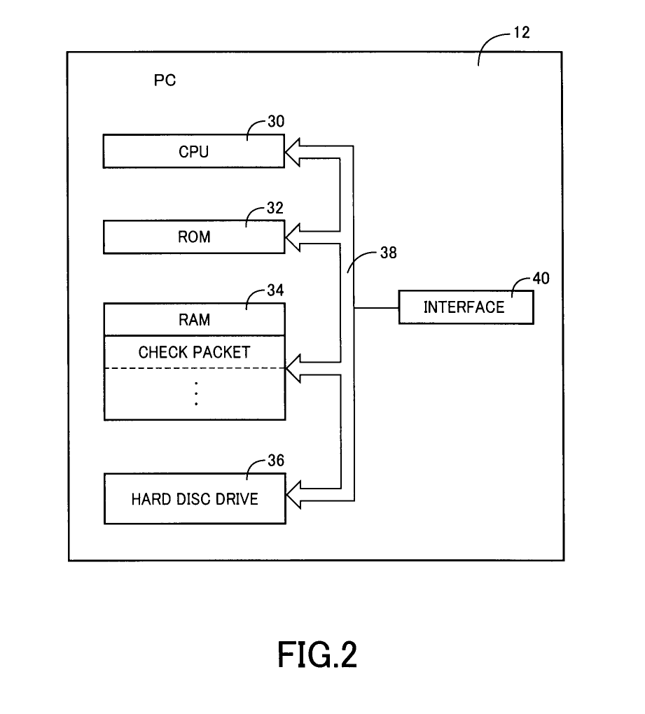

FIG. 2 conceptually illustrates in a block diagram, the hardware configuration of a representative one of the four PCs 12. Each PC 12 is configured to include therein: a CPU (Central Processing Unit) 30 which is an example of a processor; a ROM (Read-Only Memory) 32 which is an example of a non-volatile memory which is an example of a memory; a RAM (Random Access Memory) 34 which is an example of a volatile memory which is another example of a memory; and a hard disc drive 36, all of which are in electrical connection with one another via a bus 38.

The ROM 32 has previously stored therein one or more programs for use in configuring an operating system in each PC 12, and/or various application programs. In the hard disc drive 36, a required program such as an application program is installable using an external recording medium or by online.

To the bus 38, an interface 40 is also coupled. Via the interface 40, each PC 12 can be coupled to the network 14, peripheral devices, and/or external devices.

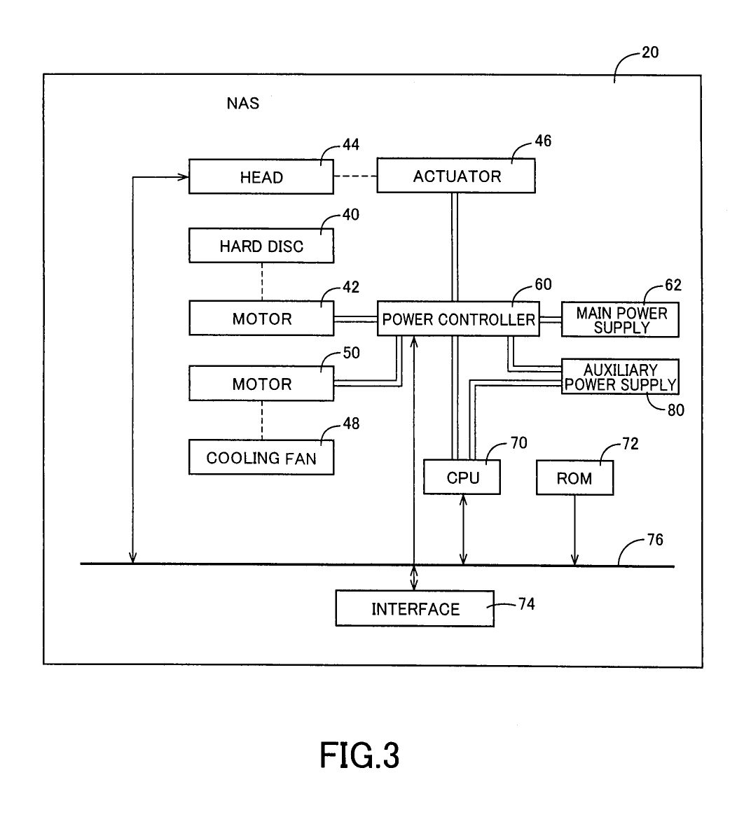

FIG. 3 conceptually illustrates the hardware configuration of the NAS 20 in a block diagram.

As is well known, the NAS 20 includes therein: a hard disc 40 in the form of a rotating body for enabling magnetic recording of data; and a motor 42 for driving the hard disc 40 for rotation.

As is well known, the NAS 20 further includes therein, a head 44 which is movable relative to the hard disc 40 in rotation, for data read/write, and an actuator 46 for driving the head 44 for movement.

As is well known, the NAS 20 still further includes therein a cooling fan 48 for cooling the motor 42, and a motor 50 for driving the cooling fan 48.

The motor 42, the actuator 46, and the motor 50 are each coupled to a main power supply 62 of the NAS 20 via a power controller 60. The motor 42, the actuator 46, and the motor 50 are each operated by consuming electric power supplied from the main power supply 62.

The NAS 20 additionally includes therein: a CPU (Central Processing Unit) 70 which is an example of a processor; a ROM (Read-Only Memory) 72 which is an example of a non-volatile memory which is an example of a memory; and an interface 74. The CPU 70, the ROM 72, and the interface 74 are in electrical connection with one another via a bus 76. To the bus 76, the head 44 and the power controller 60 are also coupled.

The power controller 60 is adapted to operate according to a command signal supplied from the CPU 70, so as to change the connected/disconnected state of the main power supply 62 and a group of the motor 42, the actuator 46, and the motor 50, to a selected one of a connected state in which the motor 42, the actuator 46, and the motor 50 are electrically connected to the main power supply 62, and a disconnected state in which the motor 42, the actuator 46, and the motor 50 are electrically disconnected from the main power supply 62.

For enabling the power controller 60 to permanently perform such a changing operation, the power controller 60 and the CPU 70 are in permanent electrical connection with an auxiliary power supply 80. The power controller 60 and the CPU 70 consume a small amount of electric power supplied from the auxiliary power supply 80, while, in particular, the motors 42 and 50 consume a large amount of electric power supplied from the main power supply 62.

In the present embodiment, the NAS 20 is adapted to make a transition (i.e., deactivation) from an active state to an inactive state, in a linked relation to the state transition (connection/disconnection) of the four PCs 12 which share the NAS 20. In the present embodiment, the state transition of the NAS 20 from an active state to an inactive state is meant to be a disconnection of the motor 42, the actuator 46, and the motor 50 from the main power supply 62.

Upon completion of the state transition of the NAS 20 from an active state to an inactive state, all of the hard disc 40, the head 44, and the cooling fan 48 are deactivated. As a result, consumption of power from the main power supply 62 is terminated, and there is also terminated generation of noise and vibration due to the rotation of the hard disc 40 and/or the cooling fan 48.

More specifically, in the present embodiment, one of the four PCs 12 (any and every one of the PCs 12 is configured to execute the same kind(s) of computer program(s) relevant to the invention, and, for the convenience of description, a representative one of the PCs 12 will be described, which is referred to as “one PC 12.”) determines, in response to a user action for shutdown of the one PC 12, whether or not three remaining PCs 12 have all been placed in a shutdown state. If the one PC 12 determines that all the three remaining PCs 12 have already been placed in a shutdown state, then the one PC 12 transmits to the NAS 20 via the network 14, a termination packet which will be described in more detail below.

Therefore, the present embodiment, when at least one of the four PCs 12 which share the same NAS 20 has been active, prevents the NAS 20 from nevertheless becoming inactive and making it unsuccessful for at least one active PC 12 to attempt to access the NAS 20.

Further, the present embodiment, when all the four PCs 12 which share the same NAS 20 have been placed in a shutdown state, allows the NAS 20 to transition from an active state to an inactive state, to thereby eliminate useless operation of the NAS 20.

Still further, the present embodiment allows the NAS 20 to make a transition (i.e., activation) from an inactive state to an active state, in a linked relation to the state transition of the four PCs 12 sharing the NAS 20. The state transition of the NAS 20 from an inactive state to an active state is meant to be a connection of the motor 42, the actuator 46 and the motor 50 to the main power supply 62.

More specifically, the one PC 12 transmits, in response to a user action for power-on, to the NAS 20 via the network 14, an activation packet which will be described in more detail below.

Therefore, the present embodiment, when at least one of the four PCs 12 which share the same NAS 20 has been active, prevents the NAS 20 from nevertheless being kept inactive, and making it unsuccessful for at least one active PC 12 to attempt to access the NAS 20.

Further, the present embodiment, when all the four PCs 12 which share the same NAS 20 has been placed in a shutdown state, allows the NAS 20 to be kept inactive, to thereby eliminate useless operation of the NAS 20.

For achieving the above-described operations, the ROM 32 or the hard disc drive 36 of each PC 12 stores therein a PC-side program which is repeatedly executed by the CPU 30 during operation of each PC 12.

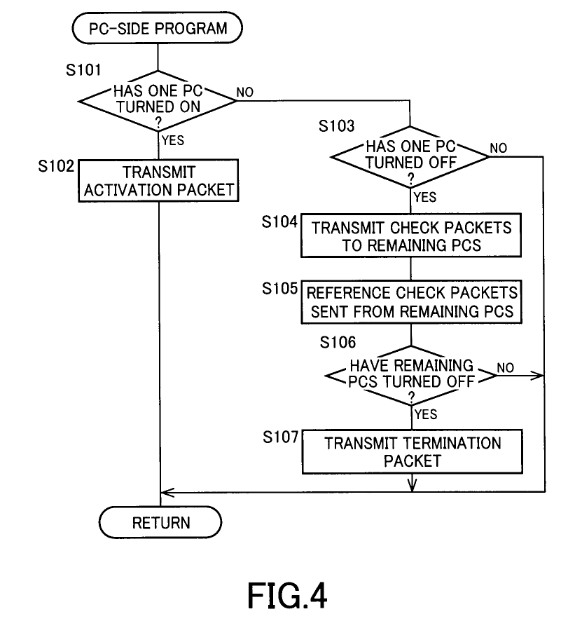

FIG. 4 conceptually illustrates the PC-side program in a flow chart. Each cycle of the PC-side program begins with step S101 to determine whether or not the one PC 12 has been switched from an OFF-state to an ON-state. In other words, a determination is made as to whether or not a user action for power-on has been conducted.

If a user action has already been conducted for switching the one PC 12 from an OFF-state to an ON-state, then a determination of step S101 becomes “YES,” and step S102 follows to transmit the activation packet to the NAS 20. The activation packet is an example of a signal for commanding activation of the NAS 20, that is to say, for switching the main power supply 62 of the NAS 20 from an OFF-state to an ON-state.

Upon completion of step S102, one cycle of the execution of this PC-side program is terminated.

While this PC-side program has been described above for a case in which a user action has already been conducted for switching the one PC 12 from an OFF-state to an ON-state, if the one PC 12 has not yet been switched from an OFF-state to an ON-state, then the determination of step S101 becomes “NO,” and step S103 follows to determine whether or not a user action has been conducted for switching the one PC 12 from an ON-state to an OFF-state. In other words, a determination is made as to whether or not a user action for shutdown has been conducted.

If a user action has been conducted for switching the one PC 12 from an ON-state to an OFF-state, then the determination of step S103 becomes “YES,” and step S104 follows to transmit a check packet to each one of the remaining PCs 12. The check packet is used for being referenced by each one of the remaining PCs 12, for allowing each PC 12 to check whether or not the one PC 12 has been shutdown.

Step S105 follows to allow the one PC 12 to reference or monitor at least one check packet which has already been received from at least one of the remaining PCs 12 and which has been stored in the RAM 34.

It is added that the one PC 12 is designed, in a similar manner to the remaining PCs 12, to receive a check packet from each one of the remaining PCs 12 and store the thus-received check packet in the RAM 34 of the one PC 12, while the one PC 12 has been placed in an ON-state. The one PC 12 is further designed to clear all check packets in the RAM 34 which have been stored therein, immediately before the one PC 12 has transitioned to an OFF-state.

Step S106 follows to make a determination as to whether or not a PC's power supply (not shown) has already been placed in an OFF-state, for every one of the three remaining PCs 12, based on information resulting from the one PC 12's reference to the stored check packet(s).

If all the power supplies of the three remaining PCs 12 have already been placed in an OFF-state, then the determination of step S106 becomes “YES,” and step S107 follows to transmit a termination packet to the NAS 20. The termination packet is an example of a signal for commanding termination of the NAS 20, that is to say, for switching the main power supply 62 of the NAS 20 from an ON-state to an OFF-state.

Upon completion of step S107, one cycle of the execution of this PC-side program is terminated.

If, however, not all the power supplies of the three remaining PCs 12 have already been placed in an OFF-state, then the determination of step S106 becomes “NO,” and step S107 is skipped. Thereafter, one cycle of the execution of this PC-side program is terminated.

While this PC-side program has been described above for a case in which a user action has already been conducted for switching the one PC 12 from an ON-state to an OFF-state, if a user action has not yet been conducted for switching the one PC 12 from an ON-state to an OFF-state, then the determination of step S103 becomes “NO,” and steps S104-S107 are all skipped. Then, one cycle of the execution of this PC-side program is terminated.

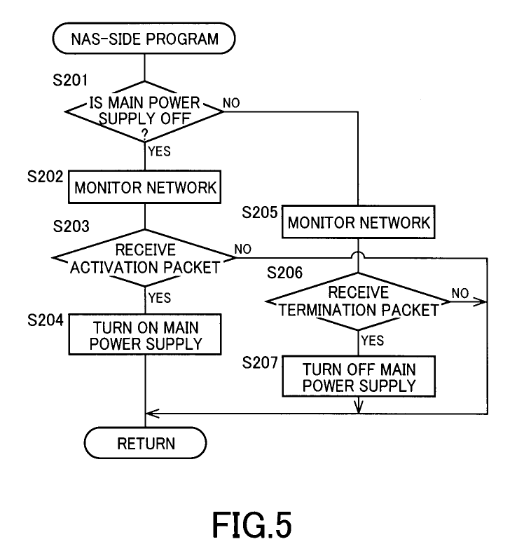

FIG. 5 conceptually illustrates in a flow chart, a NAS-side program executed by the CPU 70 of the NAS 20. This NAS-side program is executed for implementing intended operations in the NAS 20 which relates to the above-described PC-side program executed by each PC 12, to thereby achieve the purposes of the PC-side program.

The NAS-side program is repeatedly executed over time by the CPU 70, irrespective of whether the main power supply 62 of the NAS 20 has been placed in an OFF-state or an ON-state.

Each cycle of the NAS-side program begins with step S201 to determine whether or not the main power supply 62 has been placed in an OFF-state. In other words, a determination is made as to whether or not the main power supply 62 has been disconnected from the motor 42, the actuator 46, and the motor 50.

If the main power supply 62 has been placed in an OFF-state, then the determination of step S201 becomes “YES,” and step S202 follows to cause a MAC (Media Access Control) (not shown) of the NAS 20 to monitor the state of the network 14. In other words, this time, the state of the network 14 is monitored in the background by the NAS 20.

Step S203 follows to make a determination as to whether or not the NAS 20 has received an activation packet from any one of the four PCs 12. In other words, a determination is made as to whether or not the NAS 20 has received an activation packet from one of the four PCs 12 which has been powered on the earliest among them.

If the NAS 20 has received an activation packet, then the determination of step S203 becomes “YES,” and step S204 follows to switch the main power supply 62 to an ON-state. As a result, the hard disc 40 and the cooling fan 48 restart rotation.

It is added that the NAS 20 performs an operation for switching the main power supply 62 to an ON-state, only where the NAS 20 has received an activation packet from any one of the four PCs 12 during an OFF-state of the main power supply 62, while the NAS 20 disregards another activation packet, where the NAS 20 has received the activation packet from another PC 12 after the main power supply 62 has been switched to an ON-state, because the activation packet is useless.

Upon completion of step S204 is completed, one cycle of the execution of this NAS-side program is terminated.

If, however, the NAS 20 has not yet received any activation packet from any one of the four PCs 12, then the determination of step S203 becomes “NO,” and step S204 is skipped. Thereafter, one cycle of the execution of this NAS-side program is terminated.

While this NAS-side program has been described above for a case in which the main power supply 62 has been placed in an OFF-state, if the main power supply 62 has been placed in an ON-state, then the determination of step S201 becomes “NO,” and step S205 follows to allow the status of the network 14 to be monitored.

Step S206 follows to make a determination as to whether or not the NAS 20 has received a termination packet from any one of the four PCs 12. In other words, a determination is made as to whether or not the NAS 20 has received a termination packet from one of the four PCs 12 which has been shutdown the latest among them.

If the NAS 20 has received a termination packet, then the determination of step S206 becomes “YES,” and step S207 follows to switch the main power supply 62 to an OFF-state. As a result, the hard disc 40 and the cooling fan 48 stop rotation.

Upon completion of step S207, one cycle of the execution of this NAS-side program is terminated.

If, however, the NAS 20 has not yet receive any termination packet from any one of the four PCs 12, then the determination of step S206 becomes “NO,” and step S207 is skipped. Thereafter, one cycle of the execution of this NAS-side program is terminated.

It is added that, although the present embodiment is practiced such that this NAS-side program is repeatedly executed over time, the present embodiment may be alternatively practiced in a modified arrangement in which, for example, this NAS-side program is activated upon the NAS 20's reception of an activation packet or a termination packet, and this NAS-side program is executed to perform a process variable responsive to the type of the packet received by the NAS 20.

As will be evident from the foregoing explanation, for the present embodiment, it can be considered for illustrative purposes that, the single NAS 20 constitutes an example of the “single device” set forth in the first mode of the invention, and that a group of the four PCs 12 constitutes an example of the “plurality of computer units” set forth in the same mode of the invention.

Further, for the present embodiment, it can be considered for illustrative purposes that steps S103-S106 illustrated in FIG. 4 together constitute an example of the “determining step” set forth in the first mode of the invention, that step S107 illustrated in the same figure constitutes an example of the “first transmitting step” set forth in the same mode of the invention, and that the termination packet constitutes an example of the “terminate-command signal” set forth in the same mode of the invention.

Still further, for the present embodiment, it can be considered for illustrative purposes that steps S101 and S102 illustrated in FIG. 4 together constitute an example of the “second transmitting step” set forth in the second mode of the invention, and that the activation packet constitutes an example of the “activate-command signal” set forth in the same mode of the invention.

Yet further, for the present embodiment, it can be considered for illustrative purposes that the PC-side program illustrated in FIG. 4 constitutes an example of the “program” according to the eighth mode of the invention, and that one or more relevant portions of recordable devices including the ROM 32, the RAM 34, the hard disc drive 36, and an external recordable medium (although not shown, e.g., a CD-ROM which has previously stored therein the PC-side program) each constitute an example of the “recording medium” according to the ninth mode of the invention. In this regard, the one or more relevant portions have stored therein the PC-side program.

Additionally, for the present embodiment, it can be considered for illustrative purposes that each PC 12 constitutes an example of the “computer unit” set forth in the tenth mode of the invention, that a portion of each PC 12 which has been assigned a task for implementing steps S103-S106 illustrated in FIG. 4 constitutes an example of the “determining device” set forth in the same mode of the invention, and that a portion of each PC 12 which has been assigned a task for implementing step S107 illustrated in FIG. 4 constitutes an example of the “transmitting device” set forth in the same mode.

Next, a second illustrative embodiment of the present invention will be described. The present embodiment, however, will be described in greater detail only with respect to elements different from the first illustrative embodiment, the common elements will be omitted in detailed description by reference using the identical reference numerals or names, without a redundant explanation of these common elements.

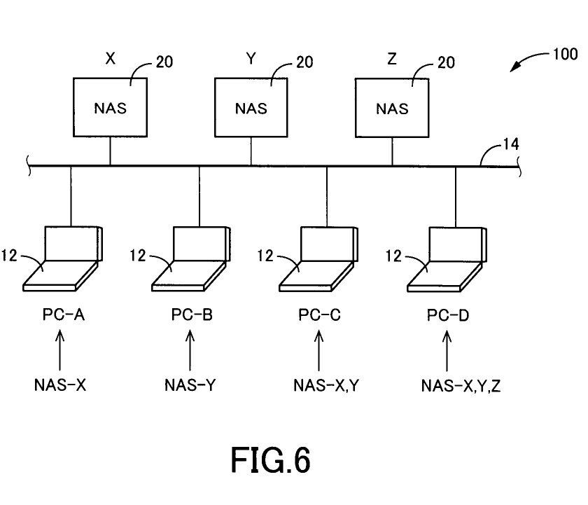

FIG. 6 conceptually illustrates a network system 100 which is used for suitably implementing a method for power management of network-attached devices, which method is constructed in accordance with the second illustrative embodiment of the present invention.

In the network system 100, similar to the first embodiment, there are the four personal computers (hereinafter, each abbreviated as “PC”) 12 which are communicatably and electrically connected with one another via the wired or wireless network 14 (e.g., a LAN, a WAN, the Internet, etc.).

The four PCs 12 are used by respective users. For the illustrative purpose, the four PCs 12 are referred to as “PC-A,” “PC-B,” “PC-C,” and “PC-D,” respectively, for denotational distinction, as with the first embodiment. Each PC 12 is common in construction to each PC 12 in the first embodiment.

To the network 14, three NASes (Network Attached Storage) 20 are connected. These NASes 20 are referred to as “NAS-X,” “NAS-Y,” and “NAS-Z,” respectively, for denotational distinction. Each NAS 20 is common in construction to the NAS 20 in the first embodiment.

In the present embodiment, not everyone of the three NASes 20 is shared by the four PCs 12. More specifically, the NAS-X is shared by the PC-A, the PC-C, and the PC-D, the NAS-Y is shared by the PC-B, the PC-C, and the PC-D, and the NAS-Z is used only by the PC-D.

In the present embodiment, each NAS 20 is adapted to make a transition (i.e., deactivation) from an active state to an inactive state, in a linked relation to the state transition (connection/disconnection) of a plurality of PCs 12 which share respective NAS 20. In the present embodiment, as with the first embodiment, the state transition of each NAS 20 from an active state to an inactive state is meant to be a disconnection of the motor 42, the actuator 46, and the motor 50 from the main power supply 62.

More specifically, in the present embodiment, the one PC 12 determines, in response to a user action for shutdown of the one PC 12, whether or not at least one selected PC 12 has been placed in a shutdown state. In this regard, the at least one selected PC 12 belongs to the three remaining PCs 12, the at least one selected PC 12 has been assigned at least one of the three NASes 20, and the at least one NAS 20 is shared by the at least one selected PC 12 and the one PC 12.

In an example, the one PC 12 refers to the PC-A, the PC-A has been assigned the NAS-X, and the NAS-X is shared by the PC-A, the PC-C, and the PC-D. Therefore, in this example, the one PC 12 determines whether or not each one of the PC-C and the PC-D has already been placed in a shutdown state.

Further, in the present embodiment, the one PC 12 transmits a terminate-command signal via the network 14 to all or a part of the at least one NAS 20 (i.e., pre-selected at least one NAS 20). In this regard, the all or the part of the at least one NAS 20 has been assigned to at least one of the three remaining PCs 12, and all of the at least one remaining PC 12 has been determined to be placed in a shutdown state.

In an example, the one PC 12 refers to the PC-A, the PC-A has been assigned the NAS-X, and the NAS-X is shared by the PC-A, the PC-C, and the PC-D. If every one of the PC-C and the PC-D has already been placed in a shutdown state, then the one PC 12 transmits a terminate-command signal to the NAS-X.

Therefore, the present embodiment, when at least one of a plurality of PCs 12 which share each NAS 20 are active, prevents each corresponding NAS 20 from nevertheless becoming inactive and making it unsuccessful for at least one active PC 12 to attempt to access each corresponding NAS 20.

Further, the present embodiment, when all of a plurality of PCs 12 which share each NAS 20 have been placed in a shutdown state, allows each corresponding NAS 20 to become inactive, to thereby eliminate useless operation of each corresponding NAS 20.

Still further, the present embodiment allows each NAS 20 to make a transition (i.e., activation) from an inactive state to an active state, in a linked relation to the state transition of a plurality of PCs 12 sharing each corresponding NAS 20. As with the first embodiment, the state transition of each NAS 20 from an inactive state to an active state is meant to be a connection of the motor 42, the actuator 46 and the motor 50 to the main power supply 62.

More specifically, the one PC 12 transmits, in response to a user action for power-on, the above-described activation packet via the network 14 at least one of the three NASes 20 which has been assigned to the one PC 12.

Therefore, the present embodiment, when at least one of a plurality of PCs 12 which share each NAS 20 has been active, prevents each corresponding NAS 20 from nevertheless being kept inactive, and making it unsuccessful for at least one active PC 12 to attempt to access each corresponding NAS 20.

Further, the present embodiment, when all of a plurality of PCs 12 which share each NAS 20 has been placed in a shutdown state, allows each corresponding NAS 20 to be kept inactive, to thereby eliminate useless operation of each corresponding NAS 20.

For achieving the above-described operations, the ROM 32 or the hard disc drive 36 of each PC 12 stores therein a PC-side program which is repeatedly executed by the CPU 30 during operation of each PC 12.

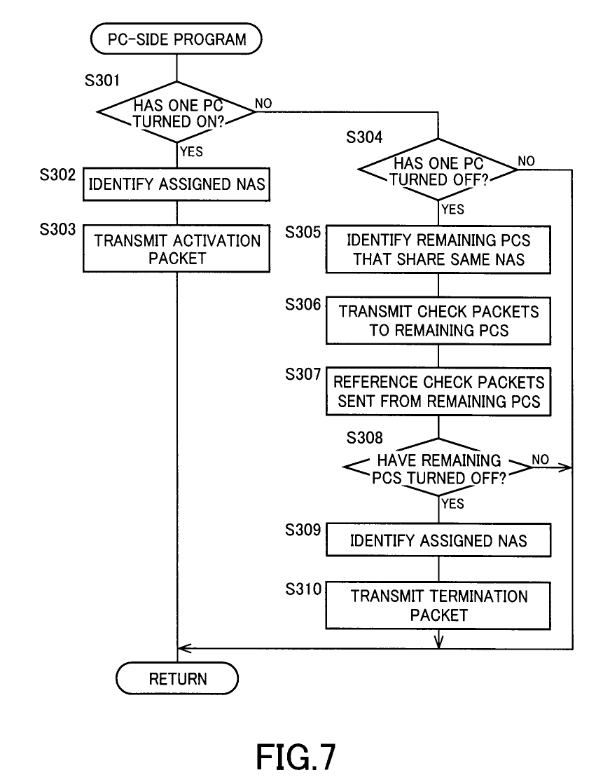

FIG. 7 conceptually illustrates the PC-side program in a flow chart. This PC-side program will be described below, while the steps common to those of the PC-side program illustrated in FIG. 4 will be omitted in detailed description, without a redundant explanation of these common steps.

Each cycle of the PC-side program illustrated in FIG. 7 begins with step S301 to determine whether or not a user action has already been conducted for switching the one PC 12 from an OFF-state to an ON-state, in a manner similar to step S101 illustrated in FIG. 4. In other words, a determination is made as to whether or not a user action (i.e., a command) for power-on has been conducted.

If a user action has already been conducted for switching the one PC 12 from an OFF-state to an ON-state, then the determination of step S301 becomes “YES,” and step S302 follows to identify at least one of the three NASes 20 which has been assigned to the one PC 12.

Step S303 follows to transmit an activation packet to the at least one NAS 20 which has been assigned to the one PC 12. The activation packet is an example of a signal for commanding the activation of each NAS 20, that is to say, for switching the main power supply 62 of each NAS 20 from an OFF-state to an ON-state.

Upon completion of step S303, one cycle of the execution of this PC-side program is terminated.

While this PC-side program has been described above for a case in which a user action has already been conducted for switching the one PC 12 from an OFF-state to an ON-state, if a user action has not yet been conducted for switching the one PC 12 from an OFF-state to an ON-state, then the determination of step S301 becomes “NO,” and step S304 follows to determine as to whether or not an operation has been performed for switching the one PC 12 from an ON-state to an OFF-state, that is to say, whether or not a user action for shutdown has been conducted.

If an user action (i.e., a command) has been conducted for switching the one PC 12 from an ON-state to an OFF-state, then the determination of step S304 becomes “YES,” and step S305 follows to identify at least one of the remaining PCs 12 with which the one PC 12 shares at least one NAS 20.

Step S306 follows to transmit the above-described check packet to the thus-identified at least one remaining PC 12. The check packet is used for being referenced by each one of the remaining PCs 12, for allowing each remaining PC 12 to check whether or not the one PC 12 has been shutdown.

Step S307 follows to allow the one PC 12 to reference or monitor at least one check packet which has already been received from each one of the identified at least one PC 12 and which has been stored in the RAM 34.

Step S308 follows to make a determination as to whether or not all of the identified at least one remaining PC 12 has already been placed in an OFF-state.

If all of the identified at least one PC 12 has been placed in an OFF-state, then the determination of step S308 becomes “YES,” and step S309 follows to identify at least one of the three NASes 20 which has been assigned to the one PC 12.

Step S310 follows to transmit a termination packet to the at least one NAS 20 which has been assigned to the one PC 12. The termination packet is an example of a signal for commanding the termination of each NAS 20, that is to say, for switching the main power supply 62 of each NAS 20 from an ON-state to an OFF-state.

Upon completion of step S310, one cycle of the execution of this PC-side program is terminated.

If, however, not all of the thus-identified at least one PC 12 has been placed in an OFF-state, then the determination of step S308 becomes “NO,” and steps S309 and S310 are skipped. Thereafter, one cycle of the execution of the PC-side program is terminated.

While this PC-side program has been described above for a case in which the one PC 12 has already been switched from an ON-state to an OFF-state, if the one PC 12 has not yet been switched, then the determination of step S304 becomes “NO,” and steps S305-S310 are skipped.

Then, one cycle of the execution of this PC-side program is terminated.

In the present embodiment, as with the first embodiment, the above-described NAS-side program is executed by the NASes 20 on a NAS-by-NAS basis, for implementing intended operations in each corresponding NAS 20 which relates to the above-described PC-side program executed by each PC 12, to thereby achieve the purposes of the PC-side program.

As will be evident from the foregoing explanation, for the present embodiment, it can be considered for illustrative purposes that, a group of the three NASes 20 constitute an example of the “plurality of devices” set forth in the sixth mode of the invention, and that a group of the four PCs 12 constitutes an example of the “plurality of computer units” set forth in the same mode of the invention.

The NAS-side program, while common to that illustrated in FIG. 5, will be omitted in detailed description without a redundant explanation thereof.

Further, for the present embodiment, it can be considered for illustrative purposes that, steps S304-S308 illustrated in FIG. 7 together constitute an example of the “determining step” set forth in the sixth mode of the invention, that steps S309 and S310 illustrated in the same figure together constitute an example of the “first transmitting step” set forth in the same mode of the invention, and that the termination packet constitutes an example of the “terminate-command signal” set forth in the same mode of the invention.

Still further, for the present embodiment, it can be considered for illustrative purposes that, steps S301-S303 illustrated in FIG. 7 together constitute an example of the “second transmitting step” set forth in the seventh mode of the invention, and that the activation packet constitutes an example of the “activate-command signal” set forth in the same mode of the invention.

Yet further, for the present embodiment, it can be considered for illustrative purposes that, the PC-side program illustrated in FIG. 7 constitutes an example of the “program” according to the eighth mode of the present invention, and that one or more relevant portions of recordable devices including the ROM 32, the RAM 34, the hard disc drive 36, and an external recordable medium (although not shown, e.g., a CD-ROM which has previously stored therein the PC-side program) each constitute an example of the “recording medium” according to the ninth mode of the invention. In this regard, the one or more relevant portions have stored therein the PC-side program.

Additionally, for the present embodiment, it can be considered for illustrative purposes that each PC 12 constitutes an example of the “computer unit” set forth in the eleventh mode of the invention, that a portion of each PC 12 which has been assigned for implementing steps S304-S308 illustrated in FIG. 7 constitutes an example of the “determining device” set forth in the same mode of the invention, and that a portion of each PC 12 which has been assigned for implementing steps S309 and S310 illustrated in FIG. 7 constitutes an example of the “transmitting device” set forth in the same mode.

It is added that, although the above-described embodiments are for practicing the invention such that power management is performed for at least one NAS shared by a plurality of PCs, the present invention may be alternatively practiced for performing power management for an alternative kind of a network-based device (e.g., a rooter, etc.) which is shared by a plurality of PCs (may be in the form of a PDA (Personal Data Assistant) or a cellular phone, each of which is computer-mounted, etc., for example), a household electrical appliance (e.g., a media player, a TV set, a refrigerator, etc.), or an office equipment (e.g., a printer, a copier, etc.).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method for power management of a single device which is shared by a plurality of computer units, in an environment in which the computer units are communicatable with the device via a wired or wireless network, the method comprising:
a determining step of determining, by each computer unit as one computer unit, in response to a command for shutdown of the one computer unit, whether or not at least one remaining computer unit has been placed in a shutdown state; and
a first transmitting step of transmitting, by the one computer unit, in response to a determination that the at least one remaining computer unit has been placed in a shutdown state, a terminate-command signal to the device via the network for termination of the device.

2. The method according to claim 1, further comprising a second transmitting step of transmitting, by the one computer unit, in response to power-on of the one computer unit, an activate-command signal to the device via the network for activation of the device.

3. The method according to claim 1, wherein the device is configured to have a motor as an actuator.

4. The method according to claim 3, wherein the device is configured to have a storage in which a recordable hard disc is driven by the motor.

5. The method according to claim 1, wherein the device is configured to have a regenerator for regenerating video or voice.

6. A method for power management of each of a plurality of devices sharable by a plurality of computer units, in an environment in which the computer units are communicatable with the devices via a wired or wireless network, the method comprising:
a determining step of determining, by each computer unit as one computer unit, in response to a command for shutdown of the one computer unit, whether or not at least one selected computer unit has been placed in a shutdown state,
wherein the at least one selected computer unit belongs to at least one remaining computer unit which is other than the one computer unit,
wherein the at least one selected computer unit has been assigned at least one of the devices, and
wherein the at least one device has been assigned to the one computer unit, whereby the at least one device is shared by the at least one selected computer unit and the one computer unit; and
a first transmitting step of transmitting, by the one computer unit, a terminate-command signal via the network to all or a part of the at least one shared device,
wherein the all or the part of the at least one shared device has been assigned to at least one other computer unit, and
wherein the at least one other computer unit has been determined to be placed in a shutdown state.

7. The method according to claim 6, further comprising a second transmitting step of transmitting, by the one computer unit, in response to power-on of the one computer unit, an activate-command signal to via the network at least one of the devices which has been assigned to the one computer unit, for activation of the at least one device.

8. A computer-readable storage medium having stored therein a computer program, when executed by a computer, to implement the method according to claim 1.

9. A computer unit which constitutes a network together with at least one other computer unit and which shares a single device with the at least one other computer unit, the device being connected to the network, the computer unit comprising:
a determining device configured, operable in response to a command for shutdown of the computer unit, to determine whether or not the at least one other computer unit has been placed in a shutdown state; and
a transmitter configured, operable in response to a determination that the at least one other computer unit has been placed in a shutdown state, to transmit a terminate-command signal to the device via the network for termination of the device.

10. A computer unit which constitutes a network together with at least one other computer unit and which shares at least one device with the at least one other computer unit, the at least one device belonging to a plurality of devices that are connected to the network, the computer unit comprising:
a determining device configured, operable in response to a command for shutdown of the computer unit, to determine whether or not at least one selected computer unit has been placed in a shutdown state,
wherein the at least one selected computer unit belongs to the at least one other computer unit,
wherein the at least one selected computer unit has been assigned at least one of the devices, and
wherein the at least one device has been assigned to the computer unit, whereby the at least one device is shared by the at least one selected computer unit and the computer unit; and
a transmitter configured to transmit a terminate-command signal via the network to all or a part of the at least one shared device,
wherein the all or the part of the at least one shared device has been assigned to at least one other computer unit, and
wherein the at least one other computer unit has been determined to be placed in a shutdown state.
